(19) United States
(12) Patent Application Publication
(10) Pub. No.: US 2026/0118743 A1
(43) Pub. Date: Apr. 30, 2026

(54) LIGHT SOURCE DEVICE, METHOD OF MANUFACTURING LIGHT SOURCE DEVICE, AND PROJECTOR

(71) Applicant: SEIKO EPSON CORPORATION, Tokyo (JP)

(72) Inventor: Takuo YONEYAMA, AZUMINO-SHI (JP)

(21) Appl. No.: 19/372,610

(22) Filed: Oct. 29, 2025

(30) Foreign Application Priority Data
Oct. 30, 2024 (JP) 2024-190443

(51) Int. Cl. G03B 21/00; G02B 26/08; G03B 21/20

(52) U.S. Cl. CPC G03B 21/005; G02B 26/0875; G03B 21/2013; G03B 21/2066

(57) ABSTRACT

A light source device includes a light source unit and a light scanning unit, wherein the light scanning unit includes a transmissive optical element that rotates about a rotational axis, and a driver that rotates the transmissive optical element. The driver includes a rotary fixation portion that fixes the transmissive optical element, and a plurality of positioning pins that are disposed at a support surface of the rotary fixation portion and are located on the same circle centered on the rotational axis. The plurality of positioning pins contact respective side surfaces of the transmissive optical element. In a cross-sectional view orthogonal to the rotational axis, intersection points between the center of the transmissive optical element and the respective side surfaces are shifted toward one side in a circumferential direction around the rotational axis.

The present application is based on, and claims priority from JP Application Serial Number 2024-190443, filed Oct. 30, 2024, the disclosure of which is hereby incorporated by reference herein in its entirety.

### BACKGROUND

### 1. Technical Field The present disclosure relates to a light source device, a method of manufacturing a light source device, and a projector.

### 2. Related Art

As a light source device used for a projector, there has been proposed a light source device that illuminates a light modulation device such as a liquid crystal panel by temporally scanning the light modulation device with light emitted from a light emitting element.

JP-A-2005-208500 discloses a projector including an illumination device that emits an illumination beam, a liquid crystal panel that modulates the illumination beam from the illumination device in accordance with image information, a projection optical system that projects the beam modulated by the liquid crystal panel, and a rotary prism disposed between the illumination device and the liquid crystal panel. In this projector, the rotary prism performs scanning with the light emitted from the illumination device by the transmissive optical element rotated by a motor. The light scanned by the rotary prism is modulated by the liquid crystal panel and is then projected onto a screen.

JP-A-2005-208500 is an example of the related art.

In the rotary prism of the projector described above, it is difficult to accurately align the rotational axis of the motor and the central axis of the transmissive optical element with each other, and there is a concern that noise and vibration due to axial wobbling may occur. Therefore, it has been desired to provide a new technique capable of suppressing the axial wobbling by simply and accurately aligning the rotational axis of the motor and the central axis of the transmissive optical element.

### SUMMARY

In order to solve the problems described above, a light source device according to an aspect of the present disclosure includes a light source unit configured to emit light, and a light scanning unit configured to periodically perform scanning with the light emitted from the light source unit, wherein the light scanning unit includes a transmissive optical element which rotates around a rotational axis extending along a direction crossing an incident direction of the light, and having a plane of incidence on which the light is incident from the light source unit and an exit surface from which the light incident on the plane of incidence is emitted, and a driver configured to rotate the transmissive optical element, the driver includes a rotary fixation portion configured to rotatably fix the transmissive optical element, and a plurality of positioning pins arranged at a support surface for the transmissive optical element in the rotary fixation portion, and located on a same circle centered on the rotational axis, the plurality of positioning pins includes a first pin having contact with a first side surface of the transmissive optical element parallel to the rotational axis, a second pin having contact with a second side surface of the transmissive optical element parallel to the rotational axis, and a third pin having contact with a third side surface of the transmissive optical element parallel to the rotational axis, and when defining, on a cross section perpendicular to the rotational axis of the transmissive optical element, an intersection point of the first side surface and a first imaginary line perpendicular to a central axis of the transmissive optical element and the first side surface as a first intersection point, an intersection point of the second side surface and a second imaginary line perpendicular to the central axis of the transmissive optical element and the second side surface as a second intersection point, and an intersection point of the third side surface and a third imaginary line perpendicular to the central axis of the transmissive optical element and the third side surface as a third intersection point, a first position of the first intersection point with respect to the first pin, a second position of the second intersection point with respect to the second pin, and a third position of the third intersection point with respect to the third pin are each shifted toward one side in a circumferential direction around the rotational axis.

A method of manufacturing a light source device according to an aspect of the present disclosure is a method of manufacturing a light source device configured to perform scanning with light emitted from a light source unit by causing the light to enter a transmissive optical element rotated by a driver, the method including arranging a jig having a plurality of positioning pins located on a same circle around a rotational axis of the driver coaxially with the rotational axis, bringing the transmissive optical element arranged at the jig into contact with a support surface of the driver, bringing at least three of the plurality of positioning pins into contact with the transmissive optical element by rotating the transmissive optical element or the jig in a circumferential direction about the rotational axis, and fixing the transmissive optical element to the support surface in a state where at least three of the plurality of positioning pins are in contact with the transmissive optical element.

A projector according to an aspect of the present disclosure includes the light source device according to the aspect of the present disclosure, a light modulation device configured to modulate light emitted from the light scanning unit of the light source device in accordance with image information, and a projection optical device configured to project image light emitted from the light modulation device.

### BRIEF DESCRIPTION OF THE DRAWINGS

FIG. 1 is a plan view showing a schematic configuration of a projector according to a first embodiment.

FIG. 2 is a side view showing a schematic configuration of the projector.

FIG. 3 is a perspective view of a first light source unit and a first light scanning unit.

FIG. 4A is a schematic diagram illustrating a behavior of light during a rotation of a transmissive optical element.

FIG. 4B is a schematic diagram showing the behavior subsequent to FIG. 4A.

FIG. 4C is a schematic diagram showing the behavior subsequent to FIG. 4B.

FIG. 4D is a schematic diagram showing the behavior subsequent to FIG. 4C.

FIG. 4E is a schematic diagram showing the behavior subsequent to FIG. 4D.

FIG. 4F is a schematic diagram showing the behavior subsequent to FIG. 4E.

FIG. 5 is a perspective view showing a configuration of an essential part of the first light scanning unit.

FIG. 6 is a cross-sectional view showing a configuration of an essential part of the first light scanning unit.

FIG. 7A shows an assembly step of the first light scanning unit.

FIG. 7B is a diagram showing a subsequent part of the assembly step shown in FIG. 7A.

FIG. 8 is a histogram showing verification results of the assembly step in the present embodiment.

FIG. 9 is a perspective view showing a configuration of an essential part of a first light scanning unit in a second embodiment.

FIG. 10 is a configuration diagram of a first transmissive optical element rotated clockwise.

FIG. 11 is a diagram showing other layouts of pins corresponding to cross-sectional shapes of the transmissive optical element.

FIG. 12 is a diagram showing configuration examples when positioning pins different in weight are used.

FIG. 13 is a diagram showing an assembly step in which positioning pins are disposed at a jig side.

### DESCRIPTION OF EMBODIMENTS

### First Embodiment

A first embodiment of the present disclosure will hereinafter be described with reference to the drawings.

A projector according to the present embodiment is an example of a liquid crystal projector using liquid crystal panels as light modulation devices.

In the following drawings, elements are drawn at different dimensional scales in some cases in order to make the elements eye-friendly.

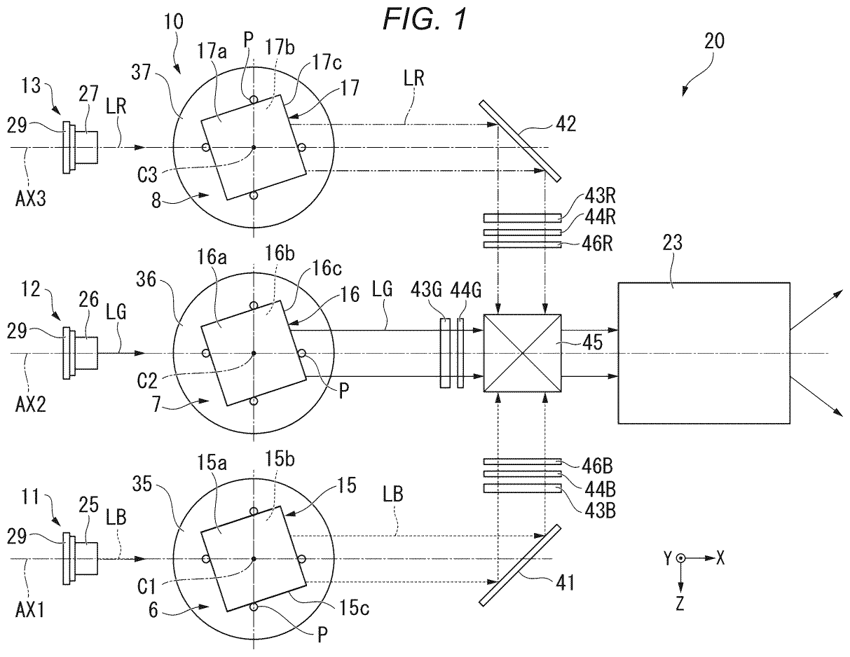

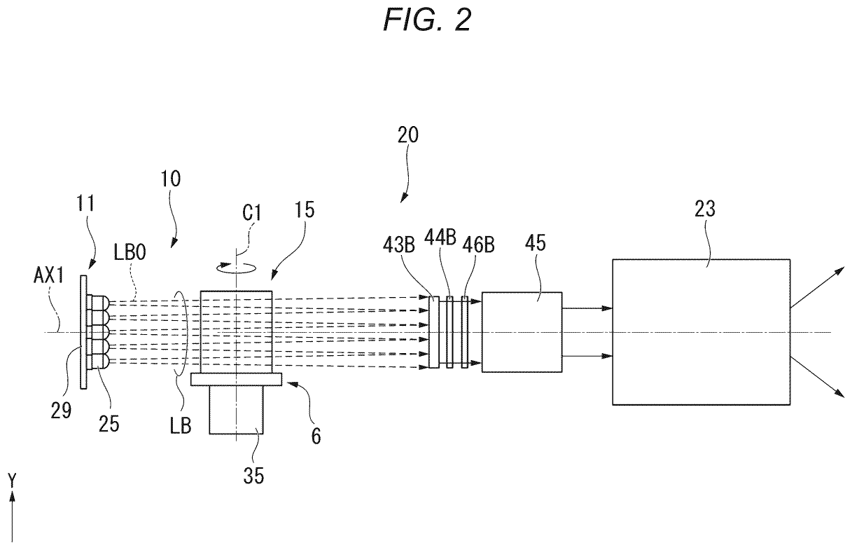

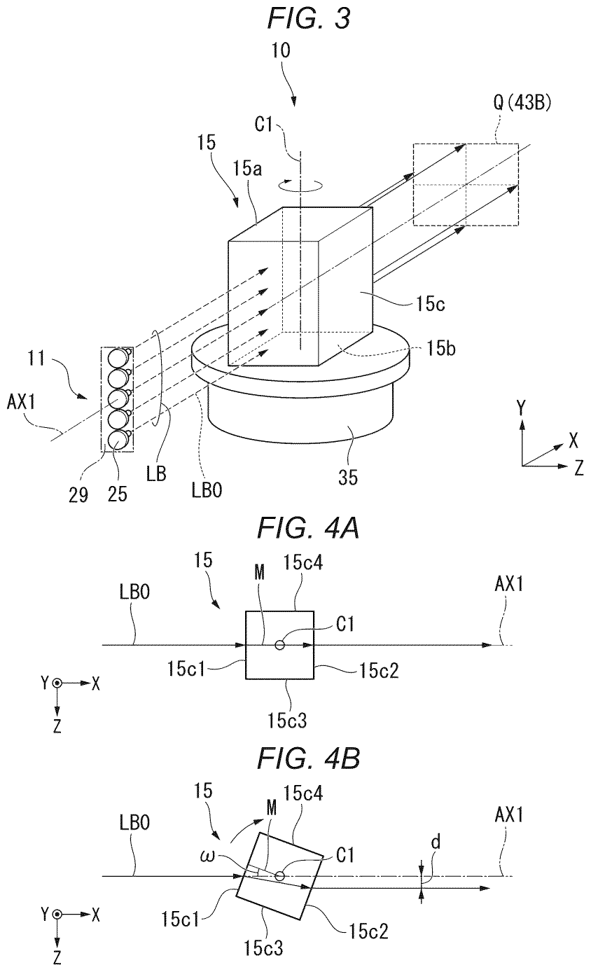

FIG. 1 is a plan view showing a schematic configuration of a projector 20 according to the present embodiment. FIG. 2 is a side view showing a schematic configuration of the projector 20. In FIG. 2, in order to make the drawing eye-friendly, only a first light source unit and a first light scanning unit are shown as an optical system in an anterior stage of the light modulation device. FIG. 3 is a perspective view of the first light source unit and the first light scanning unit.

As shown in FIGS. 1 and 2, the projector 20 according to the present embodiment includes a light source device 10, a first reflecting mirror 41, a second reflecting mirror 42, a green-light modulation device 43G, an exit-side polarization plate 44G, a blue-light modulation device 43B, an exit-side polarization plate 44B, a half-wave plate 46B, a red-light modulation device 43R, an exit-side polarization plate 44R, a half-wave plate 46R, an image light combining element 45, and a projection optical device 23. Note that the projector 20 according to the present embodiment includes the half-wave plates 46B, 46R, but is not necessarily required to include the half-wave plates 46B, 46R.

The light source device 10 according to the present embodiment includes a first light source unit 11, a second light source unit 12, a third light source unit 13, a first light scanning unit 6, a second light scanning unit 7, a third light scanning unit 8, a first driver 35, a second driver 36, and a third driver 37. The light scanning units 6, 7, and 8 respectively include transmissive optical elements 15, 16, and 17.

In the following descriptions, an X-Y-Z orthogonal coordinate system will be used as needed in the drawings. The X axis is an axis parallel to an optical axis AX2 of the second light source unit 12. The optical axis AX2 of the second light source unit 12 is defined as an axis along a principal ray of green light LG emitted from the second light source unit 12. The Y axis is an axis which is perpendicular to the X axis and extends along a rotational axis of each of the transmissive optical elements 15, 16, and 17. The Z axis is an axis perpendicular to the X axis and the Y axis. The optical axis AX1 of the first light source unit 11 is defined as an axis along a principal ray of blue light LB emitted from the first light source unit 11. An optical axis AX3 of the third light source unit 13 is defined as an axis along a principal ray of red light LR emitted from the third light source unit 13. The Y-axis direction in the present embodiment corresponds to an example of a “direction crossing an incident direction of light” in the present disclosure.

As shown in FIG. 1, the first light source unit 11 emits the blue light LB in a first wavelength band toward the first transmissive optical element 15. The second light source unit 12 emits the green light LG in a second wavelength band toward the second transmissive optical element 16. The third light source unit 13 emits the red light LR in a third wavelength band toward the third transmissive optical element 17. The first light source unit 11, the second light source unit 12, and the third light source unit 13 are arranged side by side in the Z-axis direction and emit the respective light toward the same side (+X side). According to this configuration, it is easy to share a cooling member such as a heatsink for cooling the light source units 11, 12, and 13, and it is possible to reduce the size of the light source device 10. Each of the light source units 11, 12, and 13 corresponds to an example of a “light source unit” in the present disclosure. That is, the light source device 10 according to the present embodiment includes three light source units.

Although the light source units 11, 12, and 13 are substantially the same in basic configuration, since a detailed configuration of the first light source unit 11 is illustrated in FIGS. 2 and 3, the specific configuration will be described below using the first light source unit 11 as a representative.

As shown in FIGS. 2 and 3, the first light source unit 11 includes a plurality of first light emitting elements 25 and a substrate 29. The first light emitting element 25 is formed of a laser diode that emits light in the first wavelength band. Therefore, the light emitted from the first light emitting element 25 is linearly-polarized light having coherency, and is a laser beam narrow in beam width and high in parallelism. The first wavelength band is, for example, a blue wavelength band in a range of 450±5 nm. That is, the light emitted from the first light emitting element 25 is blue light. Note that a laser diode is cited as the first light emitting element 25 in the present embodiment, but this is not a limitation, and by using a light source such as an LED or a lamp, an optical system for adjusting a polarization direction of light, an optical system for adjusting a beam width, a color wheel, and so on to generate a light beam having a ratio Lz/Ly no higher than ½, the laser diode can be replaced.

The plurality of first light emitting elements 25 is arranged in a line at predetermined intervals along the Y-axis direction, that is, the direction perpendicular to the sheet of FIG. 1. In the present embodiment, the first light source unit 11 includes five first light emitting elements 25, but the number of first light emitting elements 25 is not particularly limited as long as the plurality of first light emitting elements 25 is arranged in a single line along the Y-axis direction.

The substrate 29 supports the plurality of first light emitting elements 25. Although not shown in the drawings, a cooling member such as a heatsink for cooling the plurality of first light emitting elements 25 may be disposed at a surface at an opposite side to a side at which the plurality of first light emitting elements 25 is disposed out of the two principal surfaces of the substrate 29.

As shown in FIG. 1, the second light source unit 12 includes a plurality of second light emitting elements 26 and a substrate 29. The second light emitting element 26 is formed of a laser diode that emits light in the second wavelength band. Therefore, the light emitted from the second light emitting element 26 is linearly-polarized light having coherency, and is a laser beam narrow in beam width and high in parallelism. The second wavelength band is, for example, a green wavelength band in a range of 530±5 nm. That is, the light emitted from the second light emitting element 26 is green light.

The plurality of second light emitting elements 26 is arranged in a single line at predetermined intervals along the Y-axis direction. In the present embodiment, the second light source unit 12 includes five second light emitting elements 26, but the number of second light emitting elements 26 is not particularly limited as long as the plurality of second light emitting elements 26 is arranged in a single line along the Y-axis direction.

The third light source unit 13 includes a plurality of third light emitting elements 27 and a substrate 29. The third light emitting element 27 is formed of a laser diode that emits light in the third wavelength band. Therefore, the light emitted from the third light emitting element 27 is linearly-polarized light having coherency, and is a laser beam narrow in beam width and high in parallelism. The third wavelength band is, for example, a red wavelength band in a range of 650±5 nm. That is, the light emitted from the third light emitting element 27 is red light.

The plurality of third light emitting elements 27 is arranged in a line at predetermined intervals along the Y-axis direction, that is, the direction perpendicular to the sheet of FIG. 1. The number of third light emitting elements 27 is not particularly limited as long as the plurality of third light emitting elements 27 is arranged in a single line along the Y-axis direction.

Although the transmissive optical elements 15, 16, and 17 are substantially the same in basic configuration, since a detailed configuration of the first light scanning unit 6 is illustrated in FIGS. 2 and 3, the specific configuration will be described below using the first light scanning unit 6 as a representative. Each of the light scanning units 6, 7, and 8 corresponds to an example of a “light scanning unit” of the present disclosure. That is, the light source device 10 according to the present embodiment includes three light scanning units.

As illustrated in FIGS. 1 to 3, the first light scanning unit 6 is disposed on the optical axis AX1. The first light scanning unit 6 periodically performs scanning with the blue light LB emitted from the first light source unit 11. The first light scanning unit 6 includes a first transmissive optical element (a transmissive optical element) 15. The first transmissive optical element 15 is provided on the optical axis AX1. The first transmissive optical element 15 is formed of a light transmissive member that is rotatably supported. As the glass material of the light transmissive member constituting the first transmissive optical element 15, there is used a light transmissive material such as optical glass such as BK7, quartz, or resin. The first transmissive optical element 15 is rotatable about a first rotational axis C1 extending along the Y-axis direction crossing the X-axis direction, which is an incident direction of the blue light LB. The first transmissive optical element 15 periodically performs scanning with the blue light LB incident from the first light source unit 11. The first transmissive optical element 15 is coupled to a first driver (a driver) 35 formed of a motor or the like. The first transmissive optical element 15 rotates about the first rotational axis C1 by drive of the first driver 35.

As shown in FIG. 3, the first transmissive optical element 15 has a first surface 15a and a second surface 15b that cross the first rotational axis C1, and four side surfaces 15c in perpendicular contact with the first surface 15a and the second surface 15b. That is, the first transmissive optical element 15 has a square prismatic shape having six planar surfaces including the first surface 15a, the second surface 15b, and the four side surfaces 15c.

A cross-sectional shape of the first transmissive optical element 15 cut along a plane perpendicular to the first rotational axis C1 is a square shape. That is, the four side surfaces 15c have the same area, and the two side surfaces 15c opposed to each other are parallel to each other.

The first transmissive optical element 15 transmits the blue light LB emitted from the first light source unit 11 while rotating about the first rotational axis C1. In the first transmissive optical element 15, the side surface 15c on which the blue light LB emitted from the first light source unit 11 is incident is referred to as a first plane of incidence. The side surface 15c from which the blue light LB incident on the first plane of incidence is emitted is referred to as a first exit surface. The first plane of incidence and the first exit surface change with time, and are any two side surfaces 15c parallel to each other out of the four side surfaces 15c.

In the present specification, when two side surfaces of the transmissive optical element are referred to as surfaces parallel to each other, when an angle between the two surfaces falls within a range of 0±5 degrees is referred to as “parallel” in consideration of the processing accuracy of the glass material constituting the light transmissive member, an allowable range of the parallelism of the light, and so on.

In the case of the present embodiment, the first transmissive optical element 15 has the four side surfaces (side surfaces) 15c, but the number of side surfaces 15c is not necessarily required to be four, and is desirably 2×m (m is a natural number no smaller than 2). That is, the number of side surfaces 15c is desirably an even number such as six or eight. When the number of the side surfaces 15c is an even number, each of all the side surfaces 15c can be made parallel to opposed one of the side surfaces 15c, and there is no side surface 15c that is not parallel to any other side surfaces 15c. Thus, the stray light rarely occurs in the first transmissive optical element 15, and it is possible to increase the light use efficiency.

As shown in FIG. 1, the second transmissive optical element (the transmissive optical element) 16 is disposed on the optical axis AX2. The second transmissive optical element 16 is formed of a light transmissive member that is rotatably supported. The second transmissive optical element 16 is made rotatable around a second rotational axis (the rotational axis) C2 extending along the Y-axis direction. The second transmissive optical element 16 is coupled to the second driver (the driver) 36. The second transmissive optical element 16 rotates about the second rotational axis C2 by drive of the second driver 36.

The second transmissive optical element 16 has a third surface 16a and a fourth surface 16b that cross the second rotational axis C2, and four side surfaces 16c in perpendicular contact with the third surface 16a and the fourth surface 16b. The second transmissive optical element 16 transmits the green light LG emitted from the second light source unit 12 while rotating about the second rotational axis C2. Therefore, the side surface 16c through which the green light LG emitted from the second light source unit 12 enters the second transmissive optical element 16 is not uniquely determined, and changes with time. In the second transmissive optical element 16, the side surface 16c on which the green light LG emitted from the second light source unit 12 is incident is referred to as a second plane of incidence. The side surface 16c from which the green light LG incident on the second plane of incidence is emitted is referred to as a second exit surface. In this case, the second plane of incidence and the second exit surface change with time, and are any two side surfaces 16c parallel to each other out of the four side surfaces 16c.

In the case of the present embodiment, the second transmissive optical element 16 has the four side surfaces (side surfaces) 16c, but the number of side surfaces 16c is not necessarily required to be four, and is desirably 2×n (n is a natural number no smaller than 2). That is, the number of side surfaces 16c is desirably an even number such as six or eight. When the number of the side surfaces 16c is an even number, each of all the side surfaces 16c can be made parallel to opposed one of the side surfaces 16c, and there is no side surface 16c that is not parallel to any other side surfaces 16c. Thus, the stray light rarely occurs in the second transmissive optical element 16, and it is possible to increase the light use efficiency.

The third transmissive optical element (the transmissive optical element) 17 is disposed on the optical axis AX3. The third transmissive optical element 17 is formed of a light transmissive member that is rotatably supported. The third transmissive optical element 17 is made rotatable around a third rotational axis (the rotational axis) C3 extending along the Y-axis direction. The third transmissive optical element 17 is coupled to the third driver 37. The third transmissive optical element 17 rotates about the third rotational axis C3 by drive of the third driver (the driver) 37.

The third transmissive optical element 17 has a fifth surface 17a and a sixth surface 17b that cross the third rotational axis C3, and four side surfaces 17c in perpendicular contact with the fifth surface 17a and the sixth surface 17b. The third transmissive optical element 17 transmits the red light LR emitted from the third light source unit 13 while rotating about the third rotational axis C3. In the third transmissive optical element 17, the side surface 17c on which the red light LR emitted from the third light source unit 13 is incident is referred to as a third plane of incidence. The side surface 17c from which the red light LR incident on the third plane of incidence is emitted is referred to as a third exit surface. The third plane of incidence and the third exit surface change with time, and are any two side surfaces 17c parallel to each other out of the four side surfaces 17c.

In the case of the present embodiment, the third transmissive optical element 17 has the four side surfaces (side surfaces) 17c, but the number of side surfaces 17c is not necessarily required to be four, and is desirably 2×p (p is a natural number no smaller than 2). That is, the number of side surfaces 17c is desirably an even number such as six or eight. When the number of the side surfaces 17c is an even number, each of all the side surfaces 17c can be made parallel to opposed one of the side surfaces 17c, and there is no side surface 17c that is not parallel to any other side surfaces 17c. Thus, the stray light rarely occurs in the third transmissive optical element 17, and it is possible to increase the light use efficiency.

The first transmissive optical element 15, the second transmissive optical element 16, and the third transmissive optical element 17 are made of respective glass materials different from each other and are different in refractive index from each other. Specifically, the refractive index of the first transmissive optical element 15 is lower than the refractive index of the second transmissive optical element 16, and the refractive index of the second transmissive optical element 16 is lower than the refractive index of the third transmissive optical element 17. That is, when defining the refractive index of the first transmissive optical element 15 as n1, the refractive index of the second transmissive optical element 16 as n2, and the refractive index of the third transmissive optical element 17 as n3, a relationship of n1<n2<n3 is satisfied.

Alternatively, the first transmissive optical element 15, the second transmissive optical element 16, and the third transmissive optical element 17 may be made of quartz. In each of the transmissive optical elements 15, 16, and 17, an amount of light absorbed by the light transmissive member increases as an amount of light transmitted through the light transmissive member increases, and thermal strain may be generated in the light transmissive member in some cases. In this case, the polarization directions of the colored light LB, LG, and LR emitted from the respective light source units 11, 12, and 13 are disturbed, and the linearly-polarized light incident on the light transmissive member turns to elliptically polarized light and is emitted from the light transmissive member. As a result, it becomes unachievable to obtain an advantage that by using the laser diode for each of the light emitting elements 25, 26, and 27 in the projector 20, predetermined contrast can be obtained without providing the incident side polarization plate. That is, despite that the laser diodes are used for the light emitting elements 25, 26, and 27, there arises a necessity of using the incident side polarization plate for uniformizing the polarization directions. Therefore, in order to obtain the advantage described above, it is desirable to use a glass material low in Young's modulus and thermal expansion coefficient as the glass material small in thermal strain, and as an example, it is desirable to use quartz.

Behaviors of the colored light LB, LG, and LR when being transmitted through the transmissive optical elements 15, 16, and 17 will be described below. Note that since the behaviors of the colored light LB, LG, and LR are common to each other, the blue light LB emitted from the first light source unit 11 will be described here as a representative.

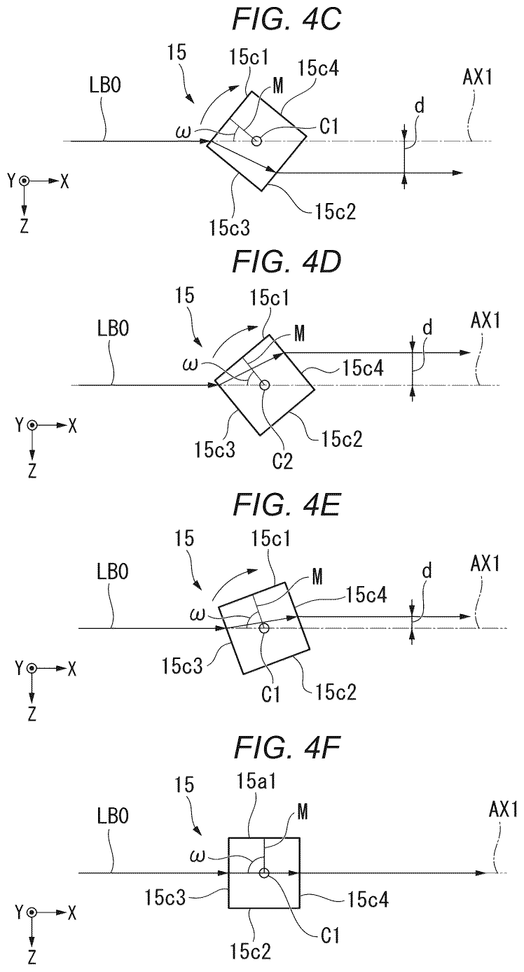

FIGS. 4A to 4F are schematic diagrams illustrating the behavior of the blue light LB during the rotation of the first transmissive optical element 15. In this example, the first transmissive optical element 15 rotates clockwise around the first rotational axis C1 when viewed from the +Y side, and in the drawings, time elapses from the state shown in FIG. 4A toward the state shown in FIG. 4F.

In FIGS. 4A to 4F, an angle between the optical axis AX1 and a straight line M, which passes through the first rotational axis C1 and is perpendicular to a first side surface 15c1 out of the four side surfaces 15c of the first transmissive optical element 15, is defined as a rotation angle ω of the first transmissive optical element 15. Actually, the blue light LB has a predetermined beam width in the Z-axis direction, but here, attention is focused on the behavior of a light beam LB0 traveling on the optical axis AX1.

FIG. 4A shows an initial state of the first transmissive optical element 15. That is, the first transmissive optical element 15 is not rotating, the straight line M overlaps the optical axis AX1, and the rotation angle ω is 0 degree. In this case, since the light beam LB0 is incident on the first side surface 15c1 at right angle, the light beam LB0 is not refracted at the first side surface 15c1 but travels inside the first transmissive optical element 15 along the optical axis AX1. Then, the beam LB0 is also incident on the second side surface 15c2, which is parallel to the first side surface 15c1, at right angle. Therefore, the light beam LB0 is also not refracted at the second side surface 15c2, but is emitted from the first transmissive optical element 15, and then travels on the optical axis AX1.

Then, as shown in FIG. 4B, when the first transmissive optical element 15 rotates by the rotation angle ω, the light beam LB0 is incident on the first side surface 15c1 at an incidence angle equal to the rotation angle ω. The light beam LB0 is therefore refracted in a direction (+Z side) shown in the drawing and then travels inside the first transmissive optical element 15. Since the light beam LB0 is also incident on the second side surface 15c2 at a predetermined incidence angle, the light beam LB0 is refracted at the second side surface 15c2 and is then emitted from the first transmissive optical element 15. On this occasion, since the first side surface 15c1 and the second side surface 15c2 are parallel to each other, the incidence angle of the light beam LB0 incident on the first side surface 15c1 and the incidence angle of the light beam LB0 incident on the second side surface 15c2 are equal to each other, and the refraction angle of the light beam LB0 incident on the first side surface 15c1 and the refraction angle of the light beam LB0 emitted from the second side surface 15c2 are opposite in sign and equal in absolute value. Accordingly, the refraction angle of the light beam LB0 incident on the first side surface 15c1 and the refraction angle of the light beam LB0 when emitted from the second side surface 15c2 are canceled each other out. As a result, the light beam LB0 travels in parallel to the optical axis AX1 at a position displaced by the displacement amount d toward the +Z side from the optical axis AX1.

Then, as shown in FIG. 4C, when the rotation angle ω of the first transmissive optical element 15 increases from the value shown in FIG. 4B, the incidence angle of the light beam LB0 increases and the refraction angle increases accordingly. Therefore, the displacement amount d of the light beam LB0 from the optical axis AX1 becomes larger than in FIG. 4B. Further, the state in which the light beam LB0 travels in parallel to the optical axis AX1 is constantly maintained. When the rotation angle ω is between 0 degree and 45 degrees, the displacement amount d monotonously increases as the rotation angle ω increases.

Then, as shown in FIG. 4D, when the rotation angle ω of the first transmissive optical element 15 exceeds 45 degrees, the plane of incidence of the light beam LB0 changes from the first side surface 15c1 to a third side surface 15c3. On this occasion, the light beam LB0 is refracted at the third side surface 15c3, but the refraction direction changes from the direction during the period up to FIG. 4C, and the light beam LB0 is refracted in a direction (-Z side) shown in the drawing. Although the exit surface of the light beam LB0 also changes from the second side surface 15c2 to a fourth side surface 15c4, since the third side surface 15c3 and the fourth side surface 15c4 are parallel to each other, the situation in which the refraction angle of the light beam LB0 incident on the third side surface 15c3 and the refraction angle of the light beam LB0 when emitted from the fourth side surface 15c4 are canceled each other out remains unchanged from the situation during the period up to FIG. 4C. As a result, the light beam LB0 travels in parallel to the optical axis AX1 at a position displaced by the displacement amount d toward the-Z side from the optical axis AX1.

Then, as shown in FIG. 4E, when the rotation angle ω of the first transmissive optical element 15 becomes larger than in FIG. 4D, the incidence angle of the light beam LB0 decreases and the refraction angle decreases accordingly. Therefore, the displacement amount d of the light beam LB0 from the optical axis AX1 becomes smaller than in FIG. 4D. As described above, when the rotation angle ω is between 45 degrees and 90 degrees, the displacement amount d monotonously decreases as the rotation angle ω increases.

Then, as shown in FIG. 4F, when the rotation angle ω of the first transmissive optical element 15 reaches 90 degrees, the plane of incidence changes from the side surface 15c1 as the initial state to the side surface 15c2, but the behavior of the light beam LB0 is the same as that in the initial state shown in FIG. 4A.

As described above, when the first plane of incidence and the first exit surface of the first transmissive optical element 15 are parallel to each other, the traveling direction of the light beam LB0 does not change regardless of the rotation angle ω of the first transmissive optical element 15, and the light beam LB0 is translated in a direction parallel to the optical axis AX1 as the time elapses. When the rotation angle ω is 0 degree, the displacement amount d of the light beam LB0 is 0, and when the rotation angle ω is between 0 degree and 45 degrees, the displacement amount d increases toward either one of the +Z side and the −Z side. At the moment when the rotation angle ω exceeds 45 degrees, the displacement direction is reversed while keeping the absolute value of the displacement amount d the same, when the rotation angle ω is between 45 degrees and 90 degrees, the displacement amount d decreases, and when the rotation angle ω reaches 90 degrees, the displacement amount d becomes 0. After the rotation angle ω exceeds 90 degrees, the behavior described above is repeated. Therefore, when the first transmissive optical element 15 makes one revolution, the displacement amount d of the light beam LB0 repeats the cycle described above four times. The displacement amount of the light beam LB0 can be appropriately set by adjusting parameters such as the refractive index and the size of the first transmissive optical element 15.

The behavior of the light has been described above focusing attention only on the light beam LB0 traveling on the optical axis AX1, but in reality, as shown in FIG. 3, the blue light LB extends linearly long in the Y-axis direction orthogonal to the Z-axis direction in which the blue light LB is displaced. Therefore, the blue light LB is reflected by the first reflecting mirror 41 described later, and then a two-dimensional illumination target area Q in an illumination target surface (the light modulation device 43B) is scanned with the blue light LB thus reflected by the first reflecting mirror 41. Further, the two-dimensional illumination target area Q in the illumination target surface (the light modulation device 43G) is scanned with the green light LG. Further, similarly to the blue light LB, the red light LR is reflected by the second reflecting mirror 42 described later, and then the two-dimensional illumination target area Q in the illumination target surface (the light modulation device 43R) is scanned with the red light LR thus reflected by the second reflecting mirror 42. As described above, when the transmissive optical elements 15, 16, and 17 are rotated around the respective rotational axes C1, C2, and C3, the transmissive optical elements 15, 16, and 17 scan the two-dimensional illumination target areas in the illumination target surfaces in a direction perpendicular to the Y-axis direction with the blue light LB, the green light LG, and the red light LR, respectively.

As shown in FIG. 1, the first reflecting mirror 41 reflects, toward the blue-light modulation device 43B, the blue light LB emitted from the first transmissive optical element 15. Thus, the first reflecting mirror 41 deflects an optical path of the blue light LB emitted from the first transmissive optical element 15 from the +X direction to the −Z direction.

The second reflecting mirror 42 reflects, toward the red-light modulation device 43R, the red light LR emitted from the third transmissive optical element 17. Thus, the second reflecting mirror 42 deflects an optical path of the red light LR emitted from the third transmissive optical element 17 from the +X direction to the +Z direction.

The blue-light modulation device 43B modulates the blue light LB emitted from the first transmissive optical element 15 of the light source device 10 in accordance with image information to form blue image light. The green-light modulation device 43G modulates the green light LG emitted from the second transmissive optical element 16 of the light source device 10 in accordance with image information to form green image light. The red-light modulation device 43R modulates the red light LR emitted from the third transmissive optical element 17 of the light source device 10 in accordance with image information to form red image light. A transmissive liquid crystal panel is used for each of the light modulation devices 43G, 43B, and 43R. A twisted nematic (TN) method, a vertical alignment (VA) method, an in-plane switching (IPS) method, and so on may be used as a method of driving the liquid crystal panel, and the method is not particularly limited.

As shown in FIG. 1, the exit-side polarization plates 44G, 44B, and 44R are disposed at the light exit side of the light modulation devices 43G, 43B, and 43R, respectively. Each of the exit-side polarization plates 44G, 44B, and 44R transmits linearly-polarized light in a specific polarization direction.

When the green image light emitted from the green-light modulation device 43G, the blue image light emitted from the blue-light modulation device 43B, and the red image light emitted from the red-light modulation device 43R enter the image light combining element 45, the image light combining element 45 combines the image light corresponding to the red light LR, the image light corresponding to the green light LG, and the image light corresponding to the blue light LB with one another to emit the image light thus combined toward the projection optical device 23. As the image light combining element 45, there is used, for example, a cross dichroic prism.

The half-wave plates 46B, 46R are provided between the blue-light modulation device 43B and the image light combining element 45 and between the red-light modulation device 43R and the image light combining element 45, respectively. The half-wave plates 46B, 46R apply a phase difference of a half wavelength to the incident colored light to rotate the polarization direction of the linearly-polarized light by 90 degrees. This makes it possible to make the polarization direction of the green light LG incident on the image light combining element 45 different from the polarization direction of the blue light LB and the red light LR incident on the image light combining element 45. According to this configuration, the efficiency of the image light combining element 45 can be increased.

The projection optical device 23 is formed of a plurality of projection lenses. The projection optical device 23 projects the image light emitted from the image light combining element 45 toward a projection target surface such as a screen in an enlarged manner. Thus, an image is displayed on the projection target surface.

Incidentally, in the light source device 10 according to the present embodiment, as described above, the configuration in which the transmissive optical elements 15, 16, and 17 are rotated by the drivers 35, 36, and 37 in the light scanning units 6, 7, and 8, respectively, is adopted. Here, when misalignments between the central axes of the transmissive optical elements 15, 16, and 17 and the rotational axes of the drivers 35, 36, and 37 increase, there is a concern that noise or vibration due to axial wobbling may occur.

In contrast, the projector 20 according to the present embodiment has a configuration in which the axes of the transmissive optical elements 15, 16, and 17 and the drivers 35, 36, and 37 are simply and accurately positioned in each of the light scanning units 6, 7, and 8. A positioning structure of the transmissive optical elements 15, 16, and 17 and the drivers 35, 36, and 37 will hereinafter be described. Note that since the positioning structure of each of the light scanning units 6, 7, and 8 is common, a positioning configuration of the first light scanning unit 6 will be described as an example.

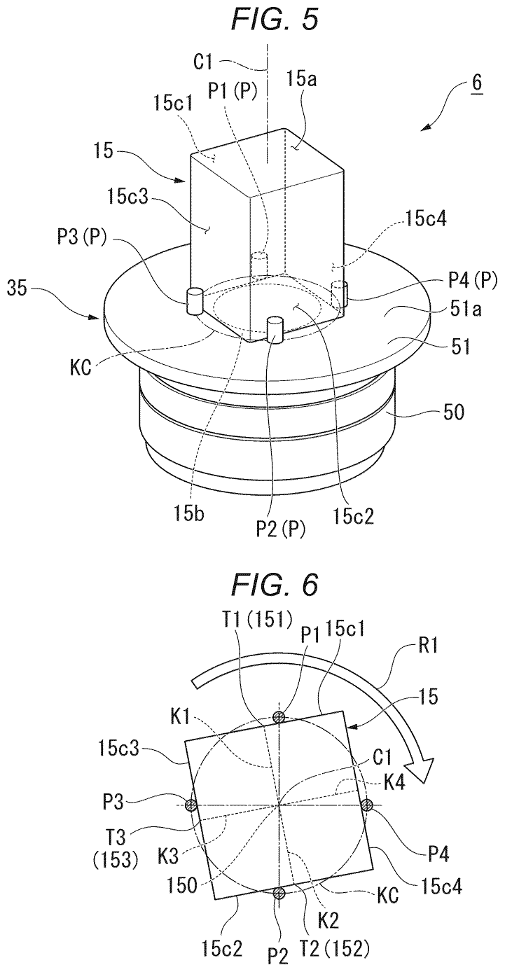

FIG. 5 is a perspective view illustrating a configuration of an essential part of the first light scanning unit 6.

The first driver 35 of the first light scanning unit 6 illustrated in FIG. 5 includes a main body portion 50 formed of a motor, a rotary fixation portion 51, and a plurality of positioning pins P. The rotary fixation portion 51 fixes the first transmissive optical element 15 rotatably around the first rotational axis C1. The rotary fixation portion 51 has a support surface 51a that supports the second surface 15b of the first transmissive optical element 15. The second surface 15b of the first transmissive optical element 15 is fixed to the support surface 51a via, for example, an adhesive.

The plurality of positioning pins P is disposed at the support surface 51a of the rotary fixation portion 51 and are located on the same circle centered on the first rotational axis C1. Specifically, the plurality of positioning pins P is located on a single circle KC indicated by an imaginary line.

In the present specification, the plurality of positioning pins P being located on the same circle centered on the first rotational axis C1 means not only when the center of each positioning pin P is located on the single circle, but also a state where the same circle overlaps any portion of each positioning pin P having a predetermined plane area. That is, in the present embodiment, the center of at least one of the plurality of positioning pins P may be arranged on the same circle, or may be arranged to be slightly shifted from the same circle.

The plurality of positioning pins P is pins for positioning the first transmissive optical element 15 with respect to the rotary fixation portion 51 of the first driver 35 such that the first rotational axis C1 of the first driver 35 and a central axis 150 of the first transmissive optical element 15 coincide with each other. In the present embodiment, the plurality of positioning pins P includes four pins. The central axis 150 of the first transmissive optical element 15 coincides with the center of gravity of the first transmissive optical element 15.

Specifically, the plurality of positioning pins P includes a first pin P1, a second pin P2, a third pin P3, and a fourth pin P4.

The first pin P1 is in contact with the first side surface 15c1 out of the four side surfaces 15c of the first transmissive optical element 15.

The second pin P2 is in contact with the second side surface 15c2 out of the four side surfaces 15c of the first transmissive optical element 15.

The third pin P3 is in contact with the third side surface 15c3 out of the four side surfaces 15c of the first transmissive optical element 15.

The fourth pin P4 faces the fourth side surface 15c4 out of the four side surfaces 15c of the first transmissive optical element 15 with a slight gap therebetween. That is, the fourth pin P4 is not in contact with the fourth side surface 15c4 of the first transmissive optical element 15.

As described above, in the first light scanning unit 6, three out of the plurality of positioning pins P are in contact with the side surfaces 15c of the first transmissive optical element 15.

In the case of the present embodiment, by using the four pins P1 to P4 as the plurality of positioning pins P, the alignment between the combined center of gravity of the pins and the first rotational axis C1 of the first driver 35 is made easier compared to when using three pins, and thus it is possible to improve easiness in assembly of the first light scanning unit 6.

FIG. 6 is a cross-sectional view illustrating a configuration of an essential part of the first light scanning unit 6 along a plane orthogonal to the first rotational axis C1. More specifically, FIG. 6 is a cross-sectional view passing through contact portions with the positioning pins P in the first transmissive optical element 15. In FIG. 6, an imaginary line orthogonal to the central axis 150 of the first transmissive optical element 15 and the first side surface 15c1 is referred to as a first imaginary line K1, an imaginary line orthogonal to the central axis 150 and the second side surface 15c2 is referred to as a second imaginary line K2, and an imaginary line orthogonal to the central axis 150 and the third side surface 15c3 is referred to as a third imaginary line K3. In addition, an intersection point of the first imaginary line K1 and the first side surface 15c1 is referred to as a first intersection point 151, an intersection point of the second imaginary line K2 and the second side surface 15c2 is referred to as a second intersection point 152, and an intersection point of the third imaginary line K3 and the third side surface 15c3 is referred to as a third intersection point 153.

On this occasion, as shown in FIG. 6, a first position T1 of the first intersection point 151 with respect to the first pin P1, a second position T2 of the second intersection point 152 with respect to the second pin P2, and a third position T3 of the third intersection point 153 with respect to the third pin P3 are shifted toward one side (counterclockwise in FIG. 6) in the circumferential direction around the first rotational axis C1.

As illustrated in FIG. 6, in the first light scanning unit 6 of the present embodiment, the first transmissive optical element 15 is rotated in a clockwise direction R1 about the first rotational axis C1. That is, the first position T1, the second position T2, and the third position T3 are shifted to an opposite side (a counterclockwise direction side) to the clockwise direction R1 side, which is the side in the rotation direction of the first transmissive optical element 15.

According to this configuration, when the rotary fixation portion 51 rotates in the clockwise direction R1, acceleration is also generated in each of the pins P1 to P3 making contact with the respective side surfaces 15c1, 15c2, and 15c3 of the first transmissive optical element 15. Therefore, since there is created the state in which the pins P1 to P3 adhere more tightly to the respective side surfaces 15c1, 15c2, and 15c3, the first transmissive optical element 15 is more stably held with respect to the rotary fixation portion 51. Therefore, detachment of the first transmissive optical element 15 from the rotary fixation portion 51 can be suppressed.

As shown in FIG. 6, each of the pins P1 to P4 has a cylindrical shape. According to this configuration, since the contact portions between the first pin P1, the second pin P2, and the third pin P3 and the respective side surfaces 15c1, 15c2, and 15c3 have linear shapes, the contact area between each of the pins P1 to P3 and the first transmissive optical element 15 can be minimized. Therefore, the positioning accuracy of the first transmissive optical element 15 by the pins P1 to P3 can be improved.

Subsequently, an assembly step of the first light scanning unit 6, which is a part of a method of manufacturing the light source device 10, will be described.

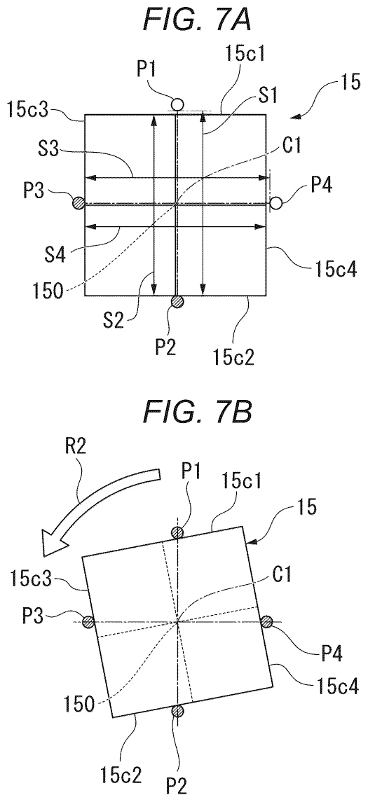

FIGS. 7A and 7B are diagrams illustrating the assembly step of the first light scanning unit 6.

First, as shown in FIG. 7A, the second surface 15b of the first transmissive optical element 15 is disposed inside a region surrounded by the plurality of positioning pins P arranged at the support surface 51a. On this occasion, the first transmissive optical element 15 is disposed such that the side surfaces 15c1, 15c2, 15c3, and 15c4 and the pins P1 to P4 face each other, respectively.

The pins P1 to P4 are disposed at the support surface 51a of the rotary fixation portion 51 such that the first rotational axis C1 passes through an intersection point of a line connecting the centers of the first pin P1 and the second pin P2 and a line connecting the centers of the third pin P3 and the fourth pin P4. In the present embodiment, the pins P1 to P4 are formed of pins the same in outer diameter and the same in weight, and the combined center of gravity of the pins P1 to P4 is set on the first rotational axis C1.

In consideration of easiness in assembly, a dimension S1 between the first pin P1 and the second pin P2 is set to be slightly larger than a dimension S2 between the first side surface 15c1 and the second side surface 15c2 of the first transmissive optical element 15, and a dimension S3 between the third pin P3 and the fourth pin P4 is set to be slightly larger than a dimension S4 between the third side surface 15c3 and the fourth side surface 15c4 of the first transmissive optical element 15. That is, in a state where the first transmissive optical element 15 is disposed in a region surrounded by the plurality of positioning pins P, a gap is generated between the side surface 15c of the first transmissive optical element 15 and each of the positioning pins P. For this reason, when the first transmissive optical element 15 is disposed so as to be biased such that the second side surface 15c2 and the third side surface 15c3 come into contact with the second pin P2 and the third pin P3, respectively, for example, as illustrated in FIG. 7A, after the first transmissive optical element 15 is disposed in the region surrounded by the plurality of positioning pins P, the first rotational axis C1 and the central axis 150 of the first transmissive optical element 15 are shifted by tolerances of the dimensions S1, S3 described above of the pins.

When the axial misalignment occurs between the first rotational axis C1 and the central axis 150 of the first transmissive optical element 15 as described above, there is a concern that noise and vibration due to the axial wobbling described above may be generated, and thus it is desirable to minimize the axial misalignment between the first rotational axis C1 and the central axis 150.

In contrast, in the assembly step in the present embodiment, it is arranged that the first transmissive optical element 15 is rotated in the circumferential direction around the first rotational axis C1 from the state illustrated in FIG. 7A. Specifically, as shown in FIG. 7B, the first transmissive optical element 15 is rotated in a counterclockwise direction R2 about the first rotational axis C1 to bring at least three of the plurality of positioning pins P into contact with the side surfaces 15c of the first transmissive optical element 15. In the case of the present embodiment, as described above, there is created the state in which the pins P1 to P3 are in contact with the respective side surfaces 15c1, 15c2, and 15c3.

Finally, the second surface 15b of the first transmissive optical element 15 is fixed to the support surface 51a in a state where the pins P1 to P3 are in contact with the respective side surfaces 15c1, 15c2, and 15c3. In this way, the first light scanning unit 6 of the present embodiment can be assembled.

The present disclosers focused attention on the fact that the axial misalignment between the first rotational axis C1 and the central axis 150 of the first transmissive optical element 15 is reduced by rotating the first transmissive optical element 15 disposed in the region surrounded by the plurality of positioning pins P around the first rotational axis C1 as described above to create the state in which at least three pins P are in contact with the side surfaces 15c of the first transmissive optical element 15, and verified the effect by simulation.

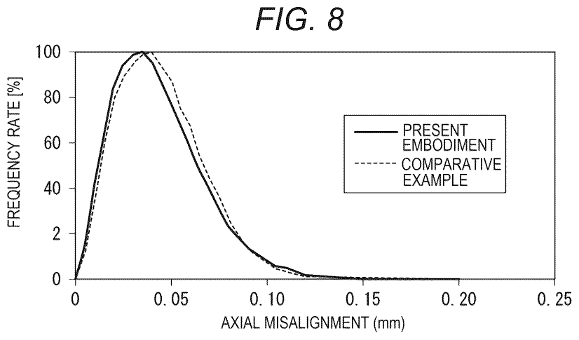

FIG. 8 is a histogram showing a result of verifying an effect when using the assembly step in the present embodiment by simulation. A solid line in FIG. 8 is a histogram corresponding to the assembly step of rotating the transmissive optical element to bring the transmissive optical element into contact with at least three pins, and a broken line in FIG. 8 is a histogram corresponding to an assembly step in a comparative example of biasing the transmissive optical element against two pins without rotating the transmissive optical element. Note that the histograms of the solid line and the broken line were calculated 30,000 times under the condition that the positions of the four pins were randomly varied by the same amount. Further, in FIG. 8, the horizontal axis represents the axial misalignment (in mm), and the vertical axis represents the frequency rate corresponding to each axial misalignment.

As shown in FIG. 8, it can be confirmed that the frequency rate of small axial misalignment increases, that is, the axial misalignment decreases in the histogram indicated by the solid line compared to the histogram indicated by the broken line. That is, according to the assembly step in the present embodiment, it can be said that the axial misalignment is smaller than that in the assembly step in the biasing method of the comparative example.

Therefore, according to the first light scanning unit 6 assembled in the assembly step in the present embodiment, by fixing the second surface 15b of the first transmissive optical element 15 to the support surface 51a in a state where the pins P1 to P3 are in contact with the respective side surfaces 15c1, 15c2, and 15c3, it is possible to easily and accurately align the first rotational axis C1 and the central axis 150 of the first transmissive optical element 15 with each other to suppress the occurrence of the axial wobbling.

Note that the second light scanning unit 7 and the third light scanning unit 8 are the same in configuration as the first light scanning unit 6. That is, as illustrated in FIG. 1, in the second light scanning unit 7, since the second transmissive optical element 16 is fixed to the second driver 36 in a state where at least three pins P are in contact with the side surfaces 16c, the second rotational axis C2 and a central axis of the second transmissive optical element 16 can be simply and accurately aligned with each other to suppress the occurrence of the axial wobbling.

In addition, in the third light scanning unit 8, since the third transmissive optical element 17 is fixed to the third driver 37 in a state where at least three pins P are in contact with the side surfaces 17c, the third rotational axis C3 and a central axis of the third transmissive optical element 17 can be simply and accurately aligned with each other to suppress the occurrence of the axial wobbling.

As described above, the light source device 10 according to the present embodiment includes the first light source unit 11 that emits the blue light LB and the first light scanning unit 6 that periodically performs the scanning with the blue light LB emitted from the first light source unit 11. The first light scanning unit 6 has the first transmissive optical element 15 that rotates about the first rotational axis C1 extending along the direction crossing the incident direction of the blue light LB and has the plane of incidence on which the blue light LB is incident from the first light source unit 11 and the exit surface from which the blue light LB incident from the incident surface is emitted, and the first driver 35 that rotates the first transmissive optical element 15.

The first driver 35 includes the rotary fixation portion 51 that fixes the first transmissive optical element 15 rotatably around the first rotational axis C1, and the plurality of positioning pins P that is disposed at the support surface 51a for the first transmissive optical element 15 in the rotary fixation portion 51 and is located on the same circle centered on the first rotational axis C1. The plurality of positioning pins P includes the first pin P1 in contact with the first side surface 15c1 of the first transmissive optical element 15, the second pin P2 in contact with the second side surface 15c2 of the first transmissive optical element 15, and the third pin P3 in contact with the third side surface 15c3 of the first transmissive optical element 15.

On the cross section of the transmissive optical element orthogonal to the first rotational axis C1, when defining the intersection point of the first imaginary line K1, which is orthogonal to the central axis 150 of the first transmissive optical element 15 and the first side surface 15c1, and the first side surface 15c1 as the first intersection point 151, the intersection point of the second imaginary line K2, which is orthogonal to the central axis 150 of the first transmissive optical element 15 and the second side surface 15c2, and the second side surface 15c2 as the second intersection point 152, and the intersection point of the third imaginary line K3, which is orthogonal to the central axis 150 of the first transmissive optical element 15 and the third side surface 15c3, and the third side surface 15c3 as the third intersection point 153, the first position T1 of the first intersection point 151 with respect to the first pin P1, the second position T2 of the second intersection point 152 with respect to the second pin P2, and the third position T3 of the third intersection point 153 with respect to the third pin P3 are shifted toward one side in the circumferential direction around the first rotational axis C1.

According to the light source device 10 of the present embodiment, it is possible to fix the first transmissive optical element 15 to the support surface 51a of the rotary fixation portion 51 in the state in which the pins P1 to P3 are in contact with the respective side surfaces 15c1, 15c2, and 15c3 of the first transmissive optical element 15 by rotating the first transmissive optical element 15 around the first rotational axis C1. Therefore, it is possible to easily and accurately align the first rotational axis C1 and the central axis 150 of the first transmissive optical element 15 with each other to suppress the occurrence of the axial wobbling compared to when arranging the first transmissive optical element 15 so as to be biased against the two positioning pins P.

Therefore, according to the light source device 10 of the present embodiment, it is possible to suppress the occurrence of noise and vibration due to the axial misalignment between the central axis 150 of the first transmissive optical element 15 and the first rotational axis C1 of the first driver 35. Further, according to the light source device 10 of the present embodiment, it is also possible to suppress the occurrence of noise and vibration due to axial misalignment between the central axes of the transmissive optical elements 16, 17 and the respective rotational axes of the drivers 36, 37.

Further, in the light source device 10 according to the present embodiment, the first position T1, the second position T2, and the third position T3 are shifted to the opposite side to the side in the rotation direction of the first transmissive optical element 15.

As a result, the pins P1 to P3 are set to the state of adhering more tightly to the respective side surfaces 15c1, 15c2, and 15c3 by the acceleration generated in each of the pins P1 to P3 when the rotary fixation portion 51 rotates. Therefore, the first transmissive optical element 15 is more stably held in the rotary fixation portion 51, and the occurrence of detachment can be suppressed.

Further, in the light source device 10 according to the present embodiment, by using the four pins P1 to P4 as the plurality of positioning pins P, the alignment between the combined center of gravity of the pins P1 to P4 and the first rotational axis C1 of the first driver 35 is facilitated. Therefore, the easiness in assembly of the first light scanning unit 6 can be improved.

Further, in the light source device 10 according to the present embodiment, since each of the pins P1 to P4 has a cylindrical shape, the contact area between each of the pins P1 to P3 and the first transmissive optical element 15 can be minimized. Accordingly, the positioning accuracy of the first transmissive optical element 15 by the pins P1 to P3 can be improved.

The projector 20 according to the present embodiment includes the light source device 10, the blue-light modulation device 43B, the green-light modulation device 43G, and the red-light modulation device 43R that modulate light emitted from the respective light scanning units 6, 7, and 8 of the light source device 10 in accordance with image information, and the projection optical device 23 that projects the light modulated by the light modulation devices 43B, 43G, and 43R.

According to the projector 20 of the present embodiment, since the light source device 10 in which the generation of noise and vibration due to axial wobbling is also suppressed is provided, a projector excellent in quietness can be realized.

Note that in the present embodiment, there is cited as an example when the first pin P1, the second pin P2, and the third pin P3 out of the plurality of positioning pins P are in contact with the side surfaces 15c of the first transmissive optical element 15, but the fourth pin P4 may be in contact with the fourth side surface 15c4 of the first transmissive optical element 15 depending on the size of the outer diameter of the pin P. That is, in the present disclosure, the advantages described above can be obtained as long as at least three of the plurality of positioning pins are in contact with the side surfaces of the transmissive optical element.

### Second Embodiment

Then, a projector according to a second embodiment of the present disclosure will be described. The present embodiment is substantially the same as the first embodiment in basic configuration of the projector, and is different from the first embodiment in the configuration of light scanning units of the light source device. Therefore, hereinafter, the first light scanning unit will be described as an example, and the description of the configurations of the second light scanning unit and the third light scanning unit will be omitted.

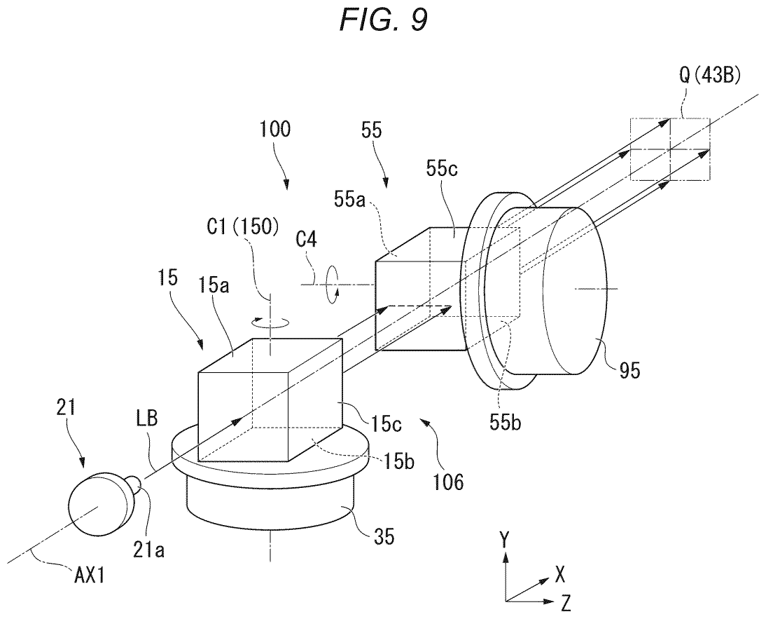

FIG. 9 is a perspective view showing a configuration of an essential part of a first light scanning unit in the present embodiment. In FIG. 9, elements common to those in the drawings in the first embodiment are denoted by the same reference symbols to omit the description thereof.

As shown in FIG. 9, in a light source device 100 according to the present embodiment, a first light source unit 21 includes a single light emitting element 21a. Therefore, the blue light LB emitted from the first light source unit 21 is formed of a single light beam.

A first light scanning unit 106 in the present embodiment includes the first transmissive optical element 15, the first driver 35, a posterior-stage transmissive optical element 55 disposed in a posterior stage of the first transmissive optical element 15, and a rotary driving device 95 that drives the posterior-stage transmissive optical element 55.

The posterior-stage transmissive optical element 55 has substantially the same configuration as that of the first transmissive optical element 15, but is installed in a posture in which the first transmissive optical element 15 is rotated by 90 degrees around the X axis. The rotary driving device 95 is a motor that rotates the posterior-stage transmissive optical element 55 about a fourth rotational axis C4 extending along the Z-axis direction.

In the case of the present embodiment, since the blue light LB is transmitted through the two transmissive optical elements 15, 55, the blue light LB is displaced in two directions orthogonal to each other over time. Specifically, as shown in FIG. 9, the first transmissive optical element 15 performs scanning in the Z-axis direction with the blue light LB emitted from the first light source unit 21, and the posterior-stage transmissive optical element 55 performs scanning in the Y-axis direction perpendicular to the Z-axis direction with the blue light LB. That is, the first transmissive optical element 15 and the posterior-stage transmissive optical element 55 scan the two-dimensional illumination target area Q (the blue-light modulation device 43B) in the illumination target surface with the blue light LB emitted from the first light source unit 21.

### Advantages of Second Embodiment

According to the light source device 100 of the present embodiment, even when using the first light scanning unit 106 that performs scanning with the single beam of the blue light LB emitted from the first light source unit 21 in two directions, it is possible to easily and accurately align the first rotational axis C1 and the central axis 150 of the first transmissive optical element 15 with each other to suppress the occurrence of the axial wobbling.

Note that the rotary driving device 95 that rotates the posterior-stage transmissive optical element 55 may adopt substantially the same configuration as that of the first driver 35 of the first transmissive optical element 15. According to this configuration, it is possible to easily and accurately align the fourth rotational axis C4 and the central axis of the posterior-stage transmissive optical element 55 with each other to suppress the occurrence of axial wobbling.

### First Modified Example

In the assembly step of the embodiment described above, as shown in FIG. 7B, there is cited as an example when the first transmissive optical element 15 is rotated counterclockwise about the first rotational axis C1, but the first transmissive optical element 15 may be rotated clockwise about the first rotational axis C1.

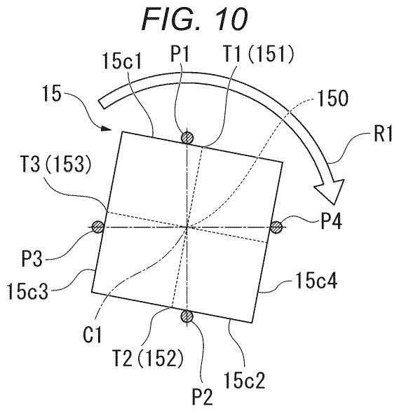

FIG. 10 is a diagram showing a configuration when the first transmissive optical element 15 is rotated clockwise about the first rotational axis C1. In order to simplify the description, also in the case shown in FIG. 10, it is assumed that each of the pins P1 to P3 is in contact with the side surface 15c of the first transmissive optical element 15.

As shown in FIG. 10, the first position T1 of the first intersection point 151 with respect to the first pin P1, the second position T2 of the second intersection point 152 with respect to the second pin P2, and the third position T3 of the third intersection point 153 with respect to the third pin P3 are shifted toward one side (clockwise) in the circumferential direction around the first rotational axis C1. That is, the first position T1, the second position T2, and the third position T3 are shifted to the same side (a clockwise direction side) as the clockwise direction R1 side, which is the side in the rotation direction of the first transmissive optical element 15.

According to this configuration, when the rotary fixation portion 51 rotates in the clockwise direction R1, acceleration is generated in a direction in which the side surfaces 15c1, 15c2, and 15c3 of the first transmissive optical element 15 get away from the respective pins P1 to P3. Therefore, since the acceleration due to the rotation of the pins P1 to P3 does not act on the respective side surfaces 15c1, 15c2, and 15c3, it is possible to suppress an occurrence of defects such as chipping and cracking of the side surfaces 15c of the first transmissive optical element 15 due to the stress from the pins P1 to P3.

### Second Modified Example

In the above description, there is cited as an example when the four positioning pins P are used for the first transmissive optical element 15 having a square cross-sectional shape along a plane orthogonal to the first rotational axis C1, but the number of positioning pins is preferably made different in accordance with the cross-sectional shape of the transmissive optical element.

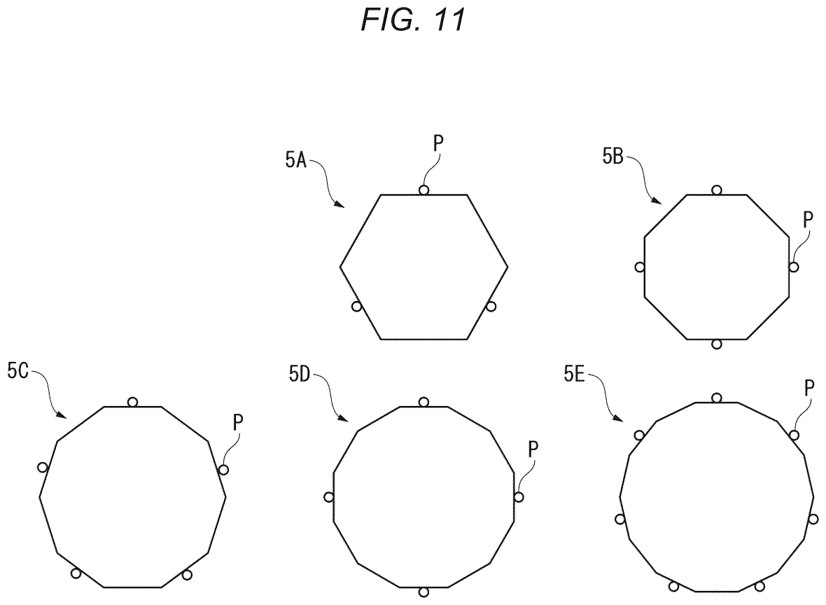

For example, when the cross-sectional shape of the transmissive optical element is a regular 2N-polygon (N is an integer) and the positioning pins are the same in weight, the positioning pins are only required to be arranged so as to form an M-polygon (M is no smaller than 3 and is a divisor of 2N). FIG. 11 is a diagram illustrating an example of the number and an arrangement of the positioning pins according to the cross-sectional shape of the transmissive optical element. As shown in FIG. 11, when a transmissive optical element 5A having a regular hexagonal cross-sectional shape is used, it is sufficient to arrange three positioning pins P so as to form a triangular shape. Further, when a transmissive optical element 5B having a regular octagonal cross-sectional shape is used, it is sufficient to arrange four positioning pins P so as to form a quadrangular shape. Further, when a transmissive optical element 5C having a regular decagonal cross-sectional shape is used, it is sufficient to arrange five positioning pins P so as to form a pentagonal shape. Further, when a transmissive optical element 5D having a regular dodecagonal cross-sectional shape is used, it is sufficient to arrange four positioning pins P so as to form a quadrangular shape. Further, when the transmissive optical element 5E having a regular tetradecagonal cross-sectional shape is used, it is sufficient to arrange seven positioning pins P so as to form a heptagonal shape. Note that although not shown, when the cross-sectional shape is a regular dodecagonal shape, three positioning pins may be arranged in a triangular shape, or six positioning pins may be arranged in a hexagonal shape.

### Third Modified Example

In the embodiment described above, there is cited as an example when the plurality of positioning pins is the same in weight as each other, but at least one of the positioning pins may be different in weight from the rest. When the positioning pins are different in weight from each other as described above, it is sufficient to design the arrangement and the weight so that the combined center of gravity of the plurality of positioning pins coincides with the center of gravity (the rotational axis) of the transmissive optical element.

In addition, when the positioning pins are not the same in weight, it is not necessary to satisfy the arrangement condition of the pins described above (the pins are arranged so as to form an M-polygon (M is no smaller than 3 and is a divisor of 2N)). For example, when the cross-sectional shape of the transmissive optical element is a regular decagonal shape, three positioning pins different in weight can be used as described later.

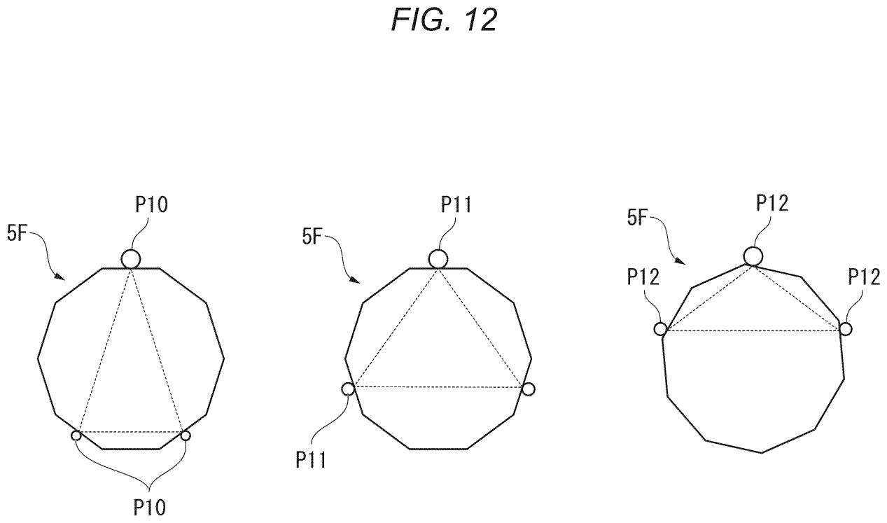

FIG. 12 is a diagram illustrating a variation of a configuration example when three positioning pins different in weight are used for a regular decagonal transmissive optical element.

As illustrated at the left side of FIG. 12, a transmissive optical element 5F having a regular decagonal shape may be held by three positioning pins P10 arranged in an isosceles triangle having an acute apex angle. In this case, the weight of the positioning pin P10 at the apex angle portion of the isosceles triangle becomes heavier than the weight of the positioning pins P10 at both ends of the base portion to create the state in which the center of gravity of the positioning pins P10 coincides with the center of gravity of the transmissive optical element.

Further, as illustrated at the center of FIG. 12, the transmissive optical element 5F having the regular decagonal shape may be held by three positioning pins P11 arranged in an isosceles triangle having an obtuse apex angle. In this case, the weight of the positioning pin P11 at the apex angle portion of the isosceles triangle becomes heavier than the weight of the positioning pins P11 at both ends of the base portion of the isosceles triangle to create the state in which the center of gravity of the positioning pins P11 coincides with the center of gravity of the transmissive optical element.

Further, as illustrated at the right side of FIG. 12, the transmissive optical element 5F having the regular decagonal shape may be held by three positioning pins P12 arranged in an isosceles triangle having an obtuse apex angle. In this case, the weight of the positioning pin P12 at the apex angle portion of the isosceles triangle becomes heavier than the weight of the positioning pins P12 at both ends of the base portion of the isosceles triangle to create the state in which the center of gravity of the positioning pins P12 fails to coincide with the center of gravity of the transmissive optical element.

As described above, according to the present disclosure, even when the center of gravity of the positioning pins P12 and the center of gravity of the transmissive optical element 5F do not coincide with each other, the axial misalignment between the rotational axis and the center of gravity (center) of the transmissive optical element 5F can be reduced by bringing the transmissive optical element 5F into contact with the three positioning pins.

Therefore, according to the present disclosure, even when the positioning pins are arranged so as to have the center of gravity which does not coincide with the center of gravity of the transmissive optical element, it is possible to suppress the occurrence of axial misalignment. According to this configuration, the degree of freedom of the layout of the positioning pins can be increased.

The technical scope of the present disclosure is not limited to the embodiments described above, and various modifications can be made therein without departing from the spirit and scope of the present disclosure.

For example, in each of the light scanning units of the embodiments described above, the positioning pins are disposed at the support surface of the rotary fixation portion of the driver, but it is also possible to position the driver and the transmissive optical element by disposing the positioning pins at an assembly jig side instead of the driver.

Hereinafter, as a modified example of the method of manufacturing the light source device, an assembly step of disposing the positioning pins at the jig side will be described as another assembly step of the light scanning unit which is a part of the manufacturing process of the light source device.

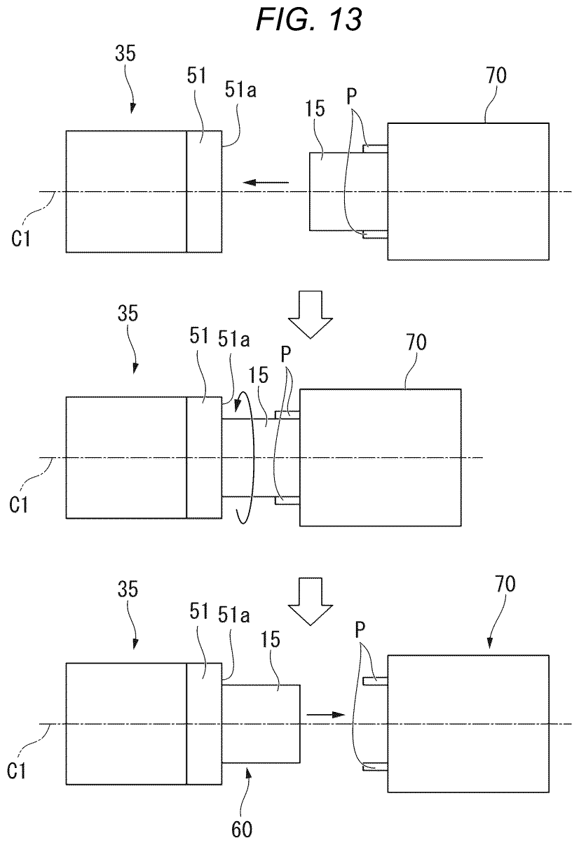

FIG. 13 is a diagram illustrating an assembly step of the first light scanning unit when the positioning pins are disposed at the jig side.

As shown in FIG. 13, as a first step, a jig 70 having a plurality of positioning pins P located on the same circle centered on the first rotational axis C1 is disposed coaxially with the first rotational axis C1 of the first driver 35.

Then, as a second step, the first transmissive optical element 15 disposed on the jig 70 is brought into contact with the support surface 51a of the rotary fixation portion 51 of the first driver 35.

Subsequently, as a third step, at least three of the plurality of positioning pins P are brought into contact with the first transmissive optical element 15 by rotating the first transmissive optical element 15 or the jig 70 in the circumferential direction about the first rotational axis C1.

Finally, as a fourth step, the first transmissive optical element 15 is fixed to the support surface 51a in a state where at least three of the plurality of positioning pins P are in contact with the first transmissive optical element 15.

In this way, the first light scanning unit 60 can be assembled. The first light scanning unit 60 is different from the first light scanning unit 6 in the embodiment described above in that the plurality of positioning pins P are not disposed at the support surface 51a side.

That is, the assembly step in the modified example includes the first step of arranging the jig 70 having the plurality of positioning pins P located on the same circle around the first rotational axis C1 of the first driver 35 coaxially with the first rotational axis C1, the second step of bringing the first transmissive optical element 15 arranged at the jig 70 into contact with the support surface 51a of the first driver 35, the third step of rotating the first transmissive optical element 15 or the jig 70 in the circumferential direction about the first rotational axis C1 to thereby bring at least three of the plurality of positioning pins P into contact with the first transmissive optical element 15, and the fourth step of fixing the first transmissive optical element 15 to the support surface 51a in the state where at least three of the plurality of positioning pins P are in contact with the first transmissive optical element 15.

Also in the first light scanning unit 60 assembled in the assembly step illustrated in FIG. 13, the first rotational axis C1 and the central axis of the first transmissive optical element 15 can be simply and accurately aligned with each other to suppress the occurrence of axial wobbling. Therefore, according to the method of manufacturing the light source device including the assembly step described above, it is possible to manufacture the light source device in which the occurrence of noise and vibration due to the axial wobbling of the first transmissive optical element 15 is suppressed.

Further, in the embodiments described above, the example in which the light source device according to the present disclosure is installed in the projector is described, but this is not a limitation. The light source device according to the present disclosure may be applied to a lighting apparatus, a headlight of an automobile, and other components.

### Summary of Present Disclosure

A summary of the present disclosure is appended below.

### Appendix 1

A light source device including:
a light source unit configured to emit light; and
a light scanning unit configured to periodically perform scanning with the light emitted from the light source unit, wherein
the light scanning unit includes
a transmissive optical element which rotates around a rotational axis extending along a direction crossing an incident direction of the light, and having a plane of incidence on which the light is incident from the light source unit and an exit surface from which the light incident on the plane of incidence is emitted, and
a driver configured to rotate the transmissive optical element,
the driver includes
a rotary fixation portion configured to rotatably fix the transmissive optical element, and
a plurality of positioning pins arranged at a support surface for the transmissive optical element in the rotary fixation portion, and located on a same circle centered on the rotational axis,
the plurality of positioning pins includes a first pin having contact with a first side surface of the transmissive optical element parallel to the rotational axis, a second pin having contact with a second side surface of the transmissive optical element parallel to the rotational axis, and a third pin having contact with a third side surface of the transmissive optical element parallel to the rotational axis, and
when defining, on a cross section perpendicular to the rotational axis of the transmissive optical element, an intersection point of the first side surface and a first imaginary line perpendicular to a central axis of the transmissive optical element and the first side surface as a first intersection point, an intersection point of the second side surface and a second imaginary line perpendicular to the central axis of the transmissive optical element and the second side surface as a second intersection point, and an intersection point of the third side surface and a third imaginary line perpendicular to the central axis of the transmissive optical element and the third side surface as a third intersection point,
a first position of the first intersection point with respect to the first pin, a second position of the second intersection point with respect to the second pin, and a third position of the third intersection point with respect to the third pin are each shifted toward one side in a circumferential direction around the rotational axis.

According to the light source device having this configuration, the transmissive optical element can be fixed to the support surface of the rotary fixation portion in a state where the three pins are in contact with the respective side surfaces of the transmissive optical element by the transmissive optical element being rotated around the rotational axis. Therefore, it is possible to easily and accurately align the rotational axis and the central axis of the transmissive optical element with each other to suppress the occurrence of the axial wobbling compared to when arranging the transmissive optical element so as to be biased against the two positioning pins. Therefore, according to the light source device having this configuration, it is possible to suppress the occurrence of noise and vibration due to axial wobbling of the transmissive optical element.

### Appendix 2

The light source device according to Appendix 1, wherein
the first position, the second position, and the third position are each shifted toward an opposite side to a side in a rotation direction of the transmissive optical element.

According to this configuration, when the rotary fixation portion rotates, acceleration is also generated in each of the pins in contact with the respective side surfaces of the transmissive optical element. Therefore, since there is created the state in which the pins adhere more tightly to the respective side surfaces of the transmissive optical element, the transmissive optical element is more stably held with respect to the rotary fixation portion. Therefore, detachment of the transmissive optical element from the rotary fixation portion can be suppressed.

### Appendix 3

The light source device according to Appendix 1, wherein
the first position, the second position, and the third position are each shifted toward a side in a rotation direction of the transmissive optical element.

According to this configuration, when the rotary fixation portion rotates, acceleration is generated in a direction in which the side surfaces of the transmissive optical element are separated from the respective pins. Therefore, since the acceleration due to the rotation of the pins does not act on the respective side surfaces of the transmissive optical element, it is possible to suppress the occurrence of defects such as chipping or cracking of the side surfaces of the transmissive optical element due to the stress from the pins.

### Appendix 4

The light source device according to any one of Appendices 1 to 3, wherein
the plurality of positioning pins further includes a fourth pin facing a fourth side surface of the transmissive optical element.

According to this configuration, for example, by the fourth pin coming into contact with the side surface of the transmissive optical element, the positioning accuracy with the positioning pins can further be improved.

### Appendix 5

The light source device according to any one of Appendices 1 to 4, wherein
the first pin, the second pin, and the third pin each have a cylindrical shape.

According to this configuration, since the contact portions between the first pin, the second pin, and the third pin and the respective side surfaces each have a linear shape, the positioning accuracy of the transmissive optical element with the pins can be improved.

### Appendix 6

The Light Source Device According to Any One of Appendices 1 to 5, wherein
one of the first pin, the second pin, and the third pin is different in weight from others.

According to this configuration, even when the combined center of gravity of the plurality of positioning pins and the center of gravity of the transmissive optical element do not coincide with each other, the axial misalignment between the center of gravity of the transmissive optical element and the rotational axis can be reduced.

### Appendix 7

The light source device according to any one of Appendices 1 to 6, wherein
the transmissive optical element includes a first surface and a second surface crossing the rotational axis, and 2×m (m is a natural number no smaller than 2) side surfaces in contact with the first surface and the second surface, and
the plane of incidence and the exit surface are two of the 2×m side surfaces parallel to each other.

According to this configuration, since there is no light incident on the side surfaces that are not parallel to each other, the stray light rarely occurs in the transmissive optical element, and it is possible to increase the light use efficiency.

### Appendix 8

A method of manufacturing a light source device configured to perform scanning with light emitted from a light source unit by causing the light to enter a transmissive optical element rotated by a driver, the method including:
arranging a jig having a plurality of positioning pins located on a same circle around a rotational axis of the driver coaxially with the rotational axis;
bringing the transmissive optical element arranged at the jig into contact with a support surface of the driver;
bringing at least three of the plurality of positioning pins into contact with the transmissive optical element by rotating the transmissive optical element or the jig in a circumferential direction about the rotational axis; and
fixing the transmissive optical element to the support surface in a state where at least three of the plurality of positioning pins are in contact with the transmissive optical element.

According to the method of manufacturing the light source device having this configuration, the transmissive optical element can be fixed to the support surface of the rotary fixation portion in a state where the three pins are in contact with the respective side surfaces of the transmissive optical element by the transmissive optical element being rotated around the rotational axis. Therefore, it is possible to easily and accurately align the rotational axis and the central axis of the transmissive optical element with each other to suppress the occurrence of the axial wobbling compared to when arranging the transmissive optical element so as to be biased against the two positioning pins. Therefore, according to the method of manufacturing the light source device having this configuration, it is possible to manufacture the light source device in which the occurrence of noise and vibration due to axial wobbling of the transmissive optical element is suppressed.

### Appendix 9

A projector including:
the light source device according to any one of Appendices 1 to 7;
a light modulation device configured to modulate light output from the light scanning unit of the light source device in accordance with image information; and
a projection optical device configured to project the light modulated by the light modulation device.

According to the projector having this configuration, since the light source device in which the generation of noise and vibration due to the axial wobbling is also suppressed is provided, a projector excellent in quietness can be realized.

What is claimed is:

1. A light source device comprising:
a light source unit configured to emit light; and
a light scanning unit configured to periodically perform scanning with the light emitted from the light source unit, wherein
the light scanning unit includes
a transmissive optical element which rotates around a rotational axis extending along a direction crossing an incident direction of the light, and having a plane of incidence on which the light is incident from the light source unit and an exit surface from which the light incident on the plane of incidence is emitted, and
a driver configured to rotate the transmissive optical element,
the driver includes
a rotary fixation portion configured to rotatably fix the transmissive optical element, and
a plurality of positioning pins arranged at a support surface for the transmissive optical element in the rotary fixation portion, and located on a same circle centered on the rotational axis,
the plurality of positioning pins includes a first pin having contact with a first side surface of the transmissive optical element parallel to the rotational axis, a second pin having contact with a second side surface of the transmissive optical element parallel to the rotational axis, and a third pin having contact with a third side surface of the transmissive optical element parallel to the rotational axis, and
when defining, on a cross section perpendicular to the rotational axis of the transmissive optical element, an intersection point of the first side surface and a first imaginary line perpendicular to a central axis of the transmissive optical element and the first side surface as a first intersection point, an intersection point of the second side surface and a second imaginary line perpendicular to the central axis of the transmissive optical element and the second side surface as a second intersection point, and an intersection point of the third side surface and a third imaginary line perpendicular to the central axis of the transmissive optical element and the third side surface as a third intersection point,
a first position of the first intersection point with respect to the first pin, a second position of the second intersection point with respect to the second pin, and a third position of the third intersection point with respect to the third pin are each shifted toward one side in a circumferential direction around the rotational axis.

2. The light source device according to claim 1, wherein
the first position, the second position, and the third position are each shifted toward an opposite side to a side in a rotation direction of the transmissive optical element.

3. The light source device according to claim 1, wherein
the first position, the second position, and the third position are each shifted toward a side in a rotation direction of the transmissive optical element.

4. The light source device according to claim 1, wherein
the plurality of positioning pins further includes a fourth pin facing a fourth side surface of the transmissive optical element.

5. The light source device according to claim 1, wherein
the first pin, the second pin, and the third pin each have a cylindrical shape.

6. The light source device according to claim 1, wherein
one of the first pin, the second pin, and the third pin is different in weight from others.

7. The light source device according to claim 1, wherein
the transmissive optical element includes a first surface and a second surface crossing the rotational axis, and 2×m (m is a natural number no smaller than 2) side surfaces in contact with the first surface and the second surface, and
the plane of incidence and the exit surface are two of the 2×m side surfaces parallel to each other.

8. A method of manufacturing a light source device configured to perform scanning with light emitted from a light source unit by causing the light to enter a transmissive optical element rotated by a driver, the method comprising:
arranging a jig having a plurality of positioning pins located on a same circle around a rotational axis of the driver coaxially with the rotational axis;
bringing the transmissive optical element arranged at the jig into contact with a support surface of the driver;
bringing at least three of the plurality of positioning pins into contact with the transmissive optical element by rotating the transmissive optical element or the jig in a circumferential direction about the rotational axis; and
fixing the transmissive optical element to the support surface in a state where at least three of the plurality of positioning pins are in contact with the transmissive optical element.

9. A projector comprising:
the light source device according to claim 1;
a light modulation device configured to modulate light output from the light scanning unit of the light source device in accordance with image information; and
a projection optical device configured to project the light modulated by the light modulation device.
